(19) United States
(12) Patent Application Publication
(10) Pub. No.: US 2013/0128387 A1
(43) Pub. Date: May 23, 2013

(54) SUSPENSION WITH HIGH CONDUCTIVITY GROUND LAYER

(71) Applicants: Eriko AJIOKA, Tokyo (JP); Yoshikazu Soeno, Tokyo (JP)

(72) Inventors: Eriko AJIOKA, Tokyo (JP); Yoshikazu Soeno, Tokyo (JP)

(73) Assignee: TDK CORPORATION, Tokyo (JP)

(21) Appl. No.: 13/302,594

(22) Filed: Nov. 22, 2011

(51) Int. Cl. G11B 5/48; G11B 21/16

(52) U.S. Cl. 360/245.2; 360/244; G9B/5.147; G9B/21.023

(57) ABSTRACT

A suspension is configured to support a magnetic head slider having a recording head element for recording data signals to a magnetic recording medium and a microwave generating element that applies a high-frequency magnetic field to the magnetic recording medium when recording is conducted by the recording head element. The suspension includes a flexure that supports the magnetic head slider and a microwave signal transmission line. The microwave signal transmission line is connected to the microwave generating element and configured to transmit microwave signals for generating the high-frequency magnetic field. A portion that supports the microwave signal transmission line of the flexure includes a lamination structure, a ground layer with the thickness of 0.1 μm or greater and less than 2 μm and having higher conductivity than that of the flexure main plate, and an insulating layer that supports the microwave signal transmission line.

### BACKGROUND OF THE INVENTION

1. Field of the Invention

The present invention relates to a suspension that supports a magnetic head slider, and more particularly relates to a support structure of a microwave signal transmission line on the suspension that is configured to mount a magnetic head for microwave assisted recording.

2. Description of the Related Art

There is a demand for improvement in recording density of magnetic disk devices that are magnetic recording devices. In order to ensure the required signal quality (signal to noise (S/N) ratio) in high density recording, there is a need to reduce the size of magnetic particles that configure a magnetic recording medium in conjunction with the improvement of surface recording density. However, the magnetic particles having reduced size are more likely to cause a magnetization disappearance due to heat fluctuation. In order to prevent this problem and maintain a stable recording state, there is a need to increase magnetic anisotropy energy of the magnetic particles. When a material with high magnetic anisotropy energy is used, coercive force of the recording magnetic recording medium is increased, and therefore, a strong recording magnetic field becomes necessary to record to the magnetic recording medium. Meanwhile, the intensity of magnetic fields generated by a recording head element is restricted by the material and the shape of the recording head element, which makes recording difficult.

In order to resolve this technical problem, energy assisted recording has been proposed in which, at the time of recording, supplemental energy is applied to a magnetic recording medium to lower effective coercive force. A recording system using a microwave magnetic field as a supplemental energy source is called microwave assisted magnetic recording (MAMR). The following references should be referred: J. G. Zhu and X. Zhu, ‘Microwave Assisted Magnetic Recording’, The Magnetic Recording Conference (TMRC) 2007 Paper B6 (2007), and Y. Wang and J. G. Zhu, ‘Media damping constant and performance characteristics in microwave assisted magnetic recording with circular ac field’ JOURNAL of Applied Physics (2009).

In microwave assisted magnetic recording, a system of supplying a microwave magnetic field with a microwave oscillator arranged in a tip end of a magnetic head, and a system of supplying microwave signals (power), the signals being supplied from a microwave signal generation circuit that is independent from the magnetic head, to a microwave generating element are known. The latter is called separate excitation system microwave assisted magnetic recording. With this system, because microwave signals (power) are supplied to a microwave generating element that is formed near a recording head element of a magnetic head slider, there is a need to provide a microwave transmission line on a suspension. Here, the suspension indicates a portion excluding the magnetic head slider from a head gimbal assembly that is, in other words, a support structure of the magnetic head slider.

Because the suspension is needed to ensure gimbal function (tracking function of the magnetic head slider above the surface of the magnetic recording medium), a stainless material that is a spring material is mainly used as a flexure main plate. JP Laid-Open Patent Application No. 2005-11387 discloses a suspension on which a non-MAMR system magnetic head is mounted. A ground layer made of copper with a thickness of 2-12 μm is provided on a surface of a flexure main plate made of stainless steel, an insulating layer made of polyimide with a thickness of 5-10 μm is formed on the ground layer, and signal transmission lines for transmitting recording/reproducing signals is formed on the insulating layer. This signal transmission line has a transmission characteristic for transmitting recording/reproducing signals of 1 GHz or less for the purpose of transmission loss reduction of the 1 GHz recording/reproducing signals.

JP Laid-Open Patent Application No. 2010-73297 discloses a suspension that supports the MAMR system magnetic head slider. A lower shield structure made of copper is provided on a surface of a flexure main plate made of stainless steel, an insulating layer made of polyimide is formed on the lower shield structure, and a microwave transmission line is formed on the insulating layer. The microwave transmission line is covered with an insulating layer, and an upper shield structure made of copper is provided on the insulating layer. The upper shield structure and the lower shield structure are reciprocally connected to each other by a plurality of columns. The lower shield structure contacts the stainless metal layer, and the lower shield structure as well as the stainless metal layer is regulated by ground potential.

In order to enhance the gimbal function, it is important to form the flexure as thin as possible and suppress bending rigidity. The thickness of the ground layer described in JP Laid-Open Patent Application No. 2005-11387 is 2-12 μm; however, when considering that the thickness of the flexure main plate is typically around 18 μm, the thickness of the ground layer is too large to ignore. In JP Laid-Open Patent Application No. 2010-73297, the shield structure for electric potential regulation is complicated and there is room to improve from a perspective of enhancing the gimbal function.

An object of the present invention is to provide a suspension that can suppress the effects on the gimbal function and that can realize a microwave signal transmission line that can reduce a transmission loss of microwave signals.

### SUMMARY OF THE INVENTION

According to one embodiment of the present invention, a suspension is configured to support a magnetic head slider having a recording head element for recording data signals to a magnetic recording medium and a microwave generating element that applies a high-frequency magnetic field to the magnetic recording medium when recording to the magnetic recording medium is conducted by the recording head element. The suspension includes a flexure that supports the magnetic head slider and a microwave signal transmission line supported by the flexure. The microwave signal transmission line being connected to the microwave generating element and configured to transmit microwave signals for generating the high-frequency magnetic field. A portion that supports the microwave signal transmission line of the flexure includes a lamination structure in which a flexure main plate, a ground layer with the thickness of 0.1 μm or greater and less than 2 μm and having higher conductivity than that of the flexure main plate, and an insulating layer that supports the microwave signal transmission line are laminated in this order.

Because the ground layer has higher conductivity than that of the flexure main plate, the ground layer can function as a ground of the microwave signal transmission line. As a result, a suitable material for the flexure main plate can be selected from the viewpoint of gimbal performance. Also, because in the case of microwave signals skin effects focally occur near a surface of the ground layer, transmission loss can be sufficiently reduced with a film thickness of 0.1 μm or more and less than 2 μm. Because the film thickness of the ground layer is extremely thin, influence on the gimbal function can be lessened.

Therefore, according to the present invention, the suspension that can suppress the effects on the gimbal function and that can realize the microwave signal transmission line that can reduce a transmission loss of microwave signals can be provided.

The above description, as well as other objects, features, and advantages of the present specification will be evident by the detailed description that follows below with reference to attached drawings exemplifying the present specification.

### BRIEF DESCRIPTION OF THE DRAWINGS

FIG. 1 is a plan view of a magnetic recording device (magnetic disk device).

FIG. 2 is a plan view of a head arm assembly.

FIGS. 3A and 3B are a plan view and a lateral view of a head gimbal assembly.

FIGS. 4A-4D are schematic views of a configuration of the head gimbal assembly and cross sections thereof.

FIGS. 5A-5C are schematic views of another configuration of the head gimbal assembly and cross sections thereof.

FIG. 6 is a schematic perspective view of a magnetic head slider.

FIG. 7 is a cross sectional view of the magnetic head slider.

FIG. 8 is a schematic view of a structure of a microwave generating element.

FIG. 9 is a schematic view for explaining the principle of a microwave assisted magnetic recording method.

FIG. 10 illustrates loss simulation of transmission lines (flexure main plate made of stainless+Cu ground layer).

FIG. 11 illustrates loss simulation of transmission lines (flexure main plate made of stainless with different conductivity+Cu ground layer).

FIG. 12 is loss simulation of transmission lines (flexure main plate made of stainless+Au ground layer).

FIG. 13 is simulation illustrating the relationship between the width of the ground layer and the transmission line loss.

FIG. 14 is loss simulation of the transmission lines in a suspension with a separate support structure (flexure main plate made of stainless+Cu ground layer).

FIG. 15 is loss simulation of the transmission lines in a suspension with a separate support structure (flexure main plate made of stainless+Au ground layer).

### DETAILED DESCRIPTION OF THE INVENTION

Hereinafter, descriptions will be given of an embodiment of the present invention with reference to drawings. The dimensions of the configuration elements and the dimensions between the configuration elements in the drawings may differ from the actual configuration for easy viewing in the drawings.

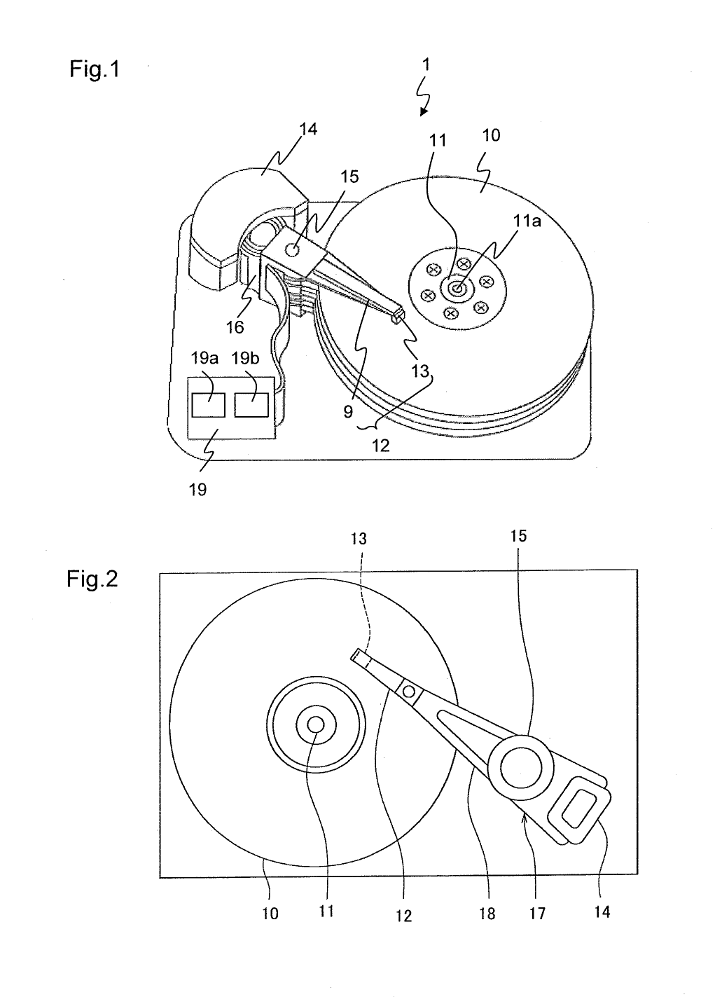

FIG. 1 illustrates a schematic perspective view of a magnetic recording/reproducing device (magnetic disk device). A magnetic recording/reproducing device 1 has a plurality of magnetic recording media (magnetic disks) 10, and a plurality of head gimbal assemblies (HGA) 12 that each includes a magnetic head slider 13. The HGA 12 is configured with the magnetic head slider 13 and a suspension 9 that supports the magnetic head slider 13. The magnetic recording medium 10 rotates around a rotational shaft 11a by a spindle motor 11. The magnetic head slider 13 writes data signals to and reads data signals from the magnetic recording medium 10. In the present invention, the magnetic head slider 13 need only be able to write data signals to the magnetic recording medium 10. The suspension 9 is firmly attached to a carriage 16 that is rotatable around a pivot bearing shaft 15. The suspension 9 conducts positioning of the magnetic head slider 13 above the magnetic recording medium 10 with a voice coil motor (VCM) 14. A recording/reproducing/resonant control circuit 19 controls writing/reading operation of the magnetic head slider 13 and also controls a microwave excitation current for ferromagnetic resonance, which will be described hereinafter. More specifically, the recording/reproducing/resonant control circuit 19 is provided with a microwave signal generation circuit 19a that is connected to a microwave signal transmission line 22c, which will be described hereinafter, and a control unit 19b of the microwave signal generation circuit 19a.

The HGA 12 may be supported by a drive arm 18 as illustrated in FIG. 2. In this case, a structure in which the HGA 12 and the drive arm 18 are combined may be called a head arm assembly 17. In any one of the configurations of FIG. 1 and FIG. 2, there is no restriction in the number of HGA 12, and only a single piece of the magnetic recording medium 10 and a single piece of the HGA 12 (and a single piece of the drive arm 18) may be provided in the magnetic recording/reproducing device 1. The following description will be given based on the configuration illustrated in FIG. 2.

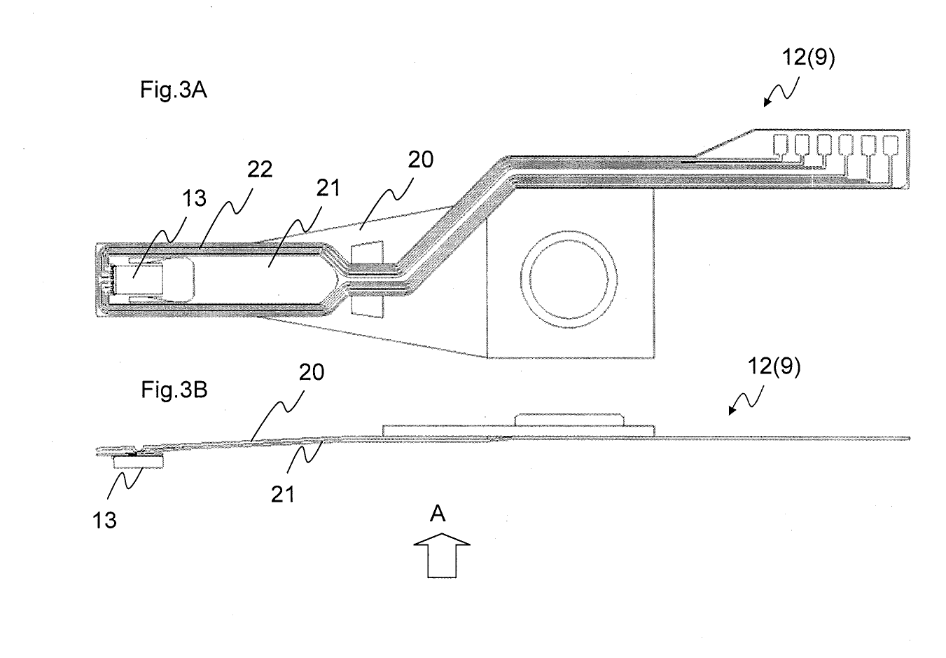

FIGS. 3A and 3B respectively illustrate a plan view (bottom view viewed from the magnetic recording medium side) and a lateral view of the suspension 9. The suspension 9 has a flexure 21 where the magnetic slider 13 is mounted on one end side thereof and a load beam 20 that presses the magnetic head slider 13 toward the surface of the magnetic recording medium 10 with a prescribed pressure. The flexure 21 is elastically deformable and has a gimbal function of making the magnetic head slider 13 follow the motion of the surface of the magnetic recording medium 10. Transmission lines 22 are formed on the surface of the flexure 21. The flexure 21 is linked to the load beam 20, and the load beam 20 is connected to the drive arm 18 that conducts positioning of the magnetic head slider 13 above the magnetic recording medium.

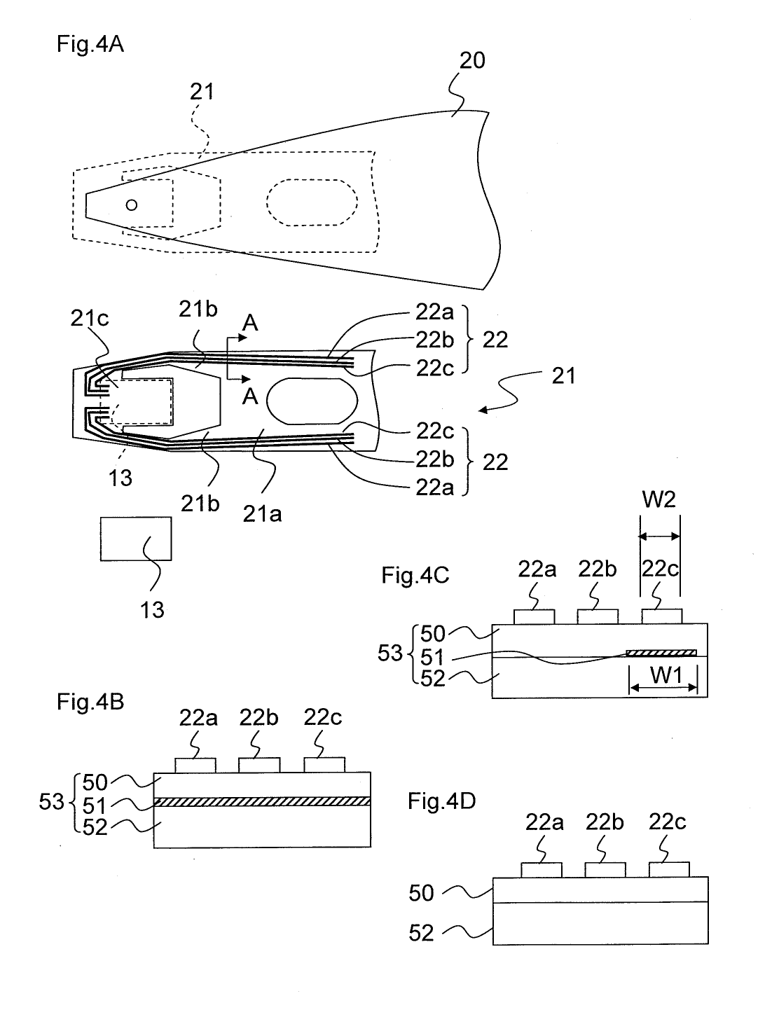

FIG. 4A is a schematic view of a configuration of the suspension 9 and paths of the transmission lines 22. This drawing is an exploded bottom view of the magnetic head slider 13, the flexure 21, and the load beam 20, which are viewed from the direction A of FIG. 3B. The flexure 21 has a main body part 21a, a support part 21c for the magnetic head slider 13, and a linkage part 21b that links the main body part 21a and the support part 21c. The linkage part 21b is composed of a pair of arm parts, and the arm parts are configured to have lower rigidity compared to the main body part 21a and the support part 21c.

The transmission lines 22 have recording signal transmission lines 22a for transmitting recording signals to a recording head element of the magnetic head slider 13, reproducing signal transmission lines 22b for taking in reproducing output voltage from a reproducing head element, and microwave signal transmission lines (excitation current transmission lines) 22c for transmitting a microwave excitation current. The transmission lines 22 may include, according to the functions of the magnetic head, a heater transmission line for adjusting flying height and a sensor transmission line for detecting flying height (both not illustrated). The transmission lines 22a, 22b, and 22c are typically formed of copper.

FIG. 4B illustrates a cross-sectional view along the line A-A of FIG. 4A. The flexure 21 has a lamination structure 53 in which a flexure main plate 52, a ground layer 51, an insulating layer 50 that supports the transmission lines 22a, 22b, and 22c are laminated in this order. The flexure main plate 52 may be formed of a metal such as stainless steel or the like; however, it may also be formed of a resin material with no conductivity. The ground layer 51 is formed of a material with higher conductivity than that of the flexure main plate 52 such as, for example, copper, gold, or silver, or an alloy of these. Accordingly, the ground layer 51 with high conductivity functions as a ground for signal transmission in the microwave frequency bands by the microwave signal transmission line 22c. As will be described later, the thickness of the ground layer 51 is preferably 0.1 μm or greater and less than 2 μm. The insulating layer 50 is formed of polyimide, and the transmission lines 22a, 22b and 22c are formed on the insulating layer 50. Although the illustration is omitted, portions between the transmission lines 22a, 22b, and 22c, and upper surfaces of the transmission lines 22a, 22b, and 22c can be covered by an insulating material such as polyimide as necessary.

In the case of transmitting signals of 1 GHz or less such as the recording/reproducing signals, even when a flexure made of stainless is used, there was no significant transmission loss. In contrast to this, in the case of transmitting microwave signals with a frequency from approximately 1 GHz to approximately 50 GHz, which is necessary for microwave assistance, transmission loss is significant because the conductivity of a stainless layer that functions as a ground is low (1.1−1.4×10⁶ [S/m]), and thereby necessary microwave power may not be supplied to a microwave generating element 39 that is positioned at a tip of the recording head element. In the present embodiment, the ground layer 51 has higher conductivity than that of the flexure main plate 52 that is typically made of stainless, and therefore transmission loss is suppressed and microwave power necessary for the microwave generating element 39 can be supplied.

The ground layer 51 is not necessarily formed on the entire surface of the flexure main plate 52, and at least the portion that supports the transmission lines 22a, 22b, and 22c, particularly the portion that supports the microwave signal transmission line 22c, needs to have the lamination structure 53 illustrated in FIG. 4B. FIG. 4C illustrates an example in which only the portion that supports the microwave signal transmission line 22c has the lamination structure 53. In that case, the upper surface of the insulating layer 50 that covers the ground layer 51 may be uneven or be planarized as illustrated in the drawing. The width W1 of the ground layer 51 under the microwave transmission line 22c is preferably the same as or greater than the width W2 of the microwave transmission line 22c.

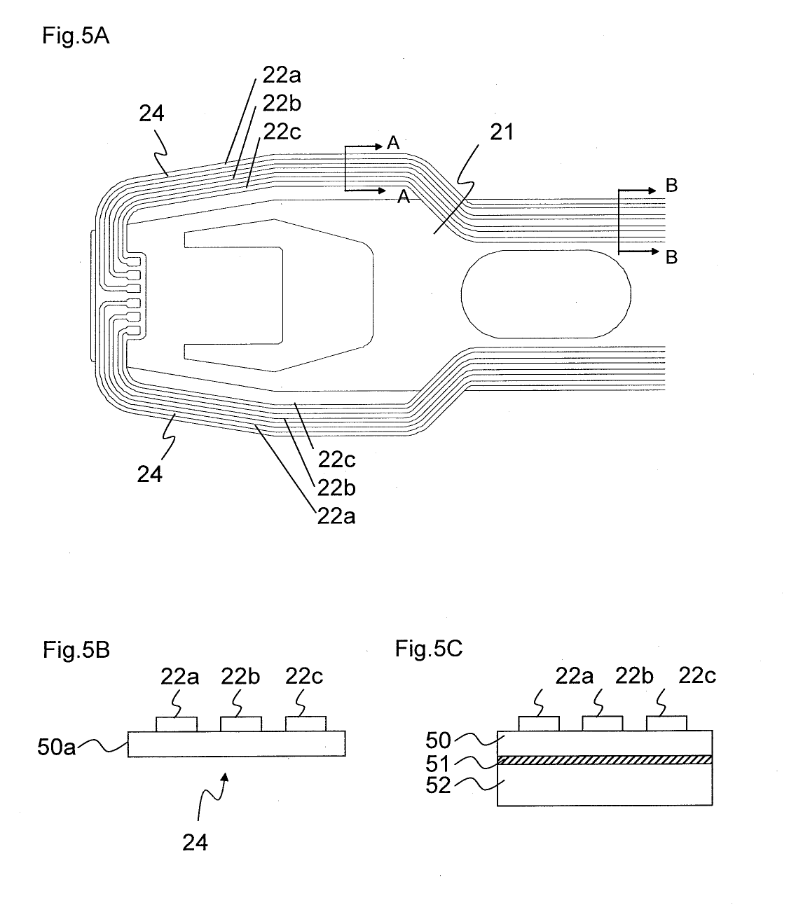

As illustrated in FIGS. 5A-5C, the transmission lines 22a, 22b, and 22c may also be supported between the main body part 21a and the support part 21c by a separate support part 24, which have an insulating property and which are provided separately from the flexure 21. FIG. 5A is a plan view similar to FIG. 4A, and FIGS. 5B and 5C are respectively cross-sectional views along the line A-A and the line B-B of FIG. 5A. The cross section illustrated in FIG. 5C is the same as the cross section illustrated in FIG. 4B. It is preferred that the linkage part 21b is arranged to be lighter in weight and be lower in rigidity from the perspective of the gimbal function. There is no need to place the transmission lines 22a, 22b, and 22c in the linkage part 21b because a path bypassing the linkage part 21b is formed by the separate support part 24, and the light-weight and the low-rigidity of the linkage part 21b can be enhanced. The separate support part 24 may be formed by an insulating layer 50a made of polyimide or the like, and the material thereof may be the same as that of the insulating layer 50.

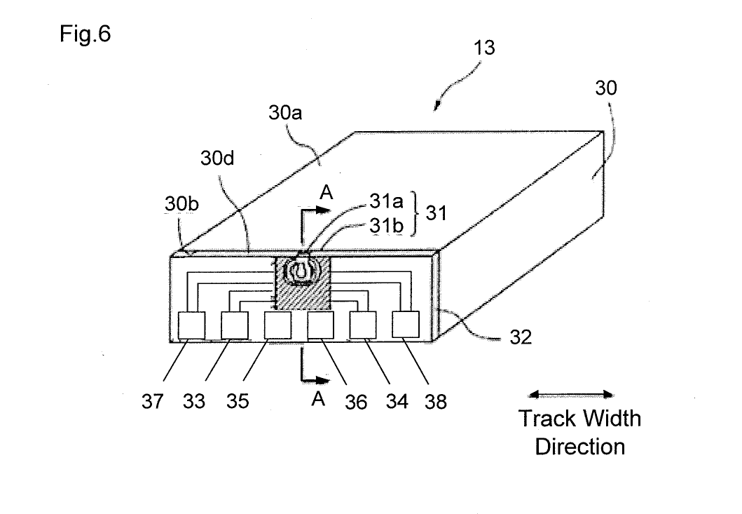

FIG. 6 is a perspective view schematically illustrating the entirety of the magnetic head slider 13 in the present embodiment. The magnetic head slider 13 is provided with a magnetic head slider substrate 30 having an air bearing surface (ABS) 30a that has been processed so as to obtain a suitable flying height, a magnetic head element 31 provided on an element formation surface 30b that is perpendicular to the ABS 30a, a protective part 32 provided on the element formation surface 30b so as to cover the magnetic head element 31, and six terminal electrodes 33, 34, 35, 36, 37, and 38 that are exposed from the surface of the protective part 32. The positions of the terminal electrodes 33, 34, 35, 36, 37, and 38 are not limited to the positions illustrated in FIG. 6, and they may be provided in any arrangement and in any positions on the element formation surface 30b. When a heater and/or a sensor are provided, at least a terminal electrode that is electrically connected to them is provided.

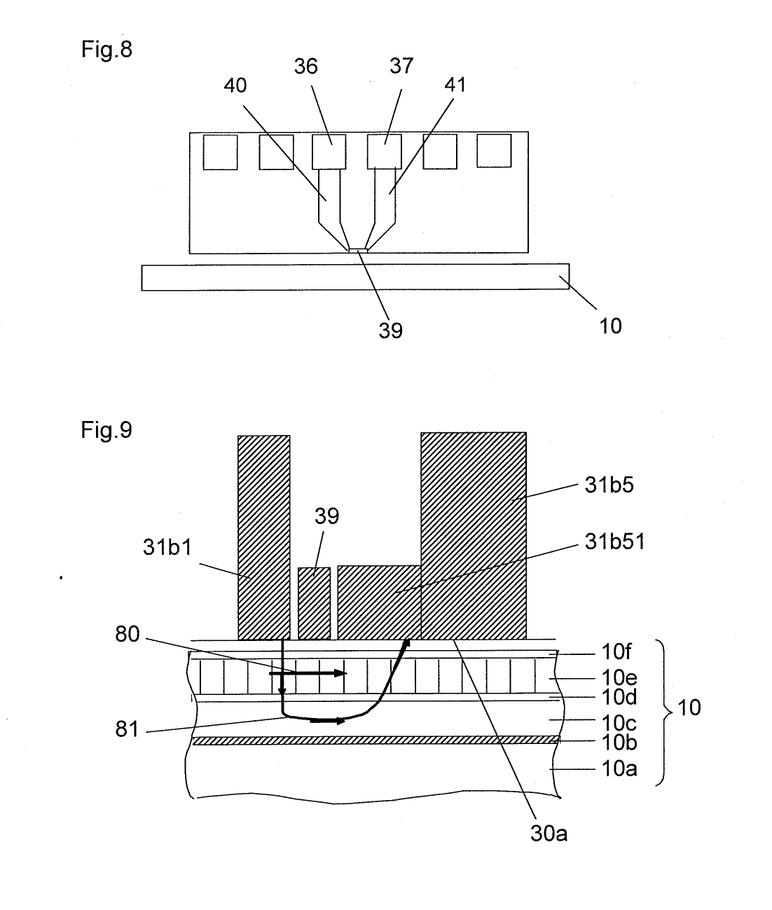

The magnetic head slider 13 is mainly configured with a magneto-resistive effect (MR) reproducing head element 31a for reading data signals from the magnetic recording medium, and a recording head element 31b for writing data signals to the magnetic recording medium. The terminal electrodes 33 and 34 are electrically connected to the MR reproducing head element 31a, the terminal electrodes 37 and 38 are electrically connected to the recording head element 31b, and the terminal electrodes 35 and 36 are electrically connected to the microwave generating element 39 (FIG. 8), which will be described hereinafter.

Tip ends of the transmission lines 22a, 22b, and 22c on the magnetic head slider 13 side are respectively connected to terminal electrodes of the recording head element 31b, the reproducing head element 31a, and the microwave generating element 39 by ball bonding in the present embodiment. Also, the transmission lines 22a, 22b, and 22c may respectively be connected to the terminal electrodes by wire bonding instead of ball bonding.

In the MR reproducing head element 31a and the recording head element 31b, the respective end parts of the elements are positioned on the ABS 30a (more specifically, on a magnetic head slider end surface 30d of the ABS 30a). When one end of the MR reproducing head element 31a and one end of the recording head element 31b oppose the magnetic recording medium, reproduction of data signals by sensing a signal magnetic field and recording of data signals by applying a signal magnetic field are conducted. An extremely thin diamond-like carbon (DLC) or the like is coated for protection on the respective end parts of the elements on the ABS 30a and its vicinity.

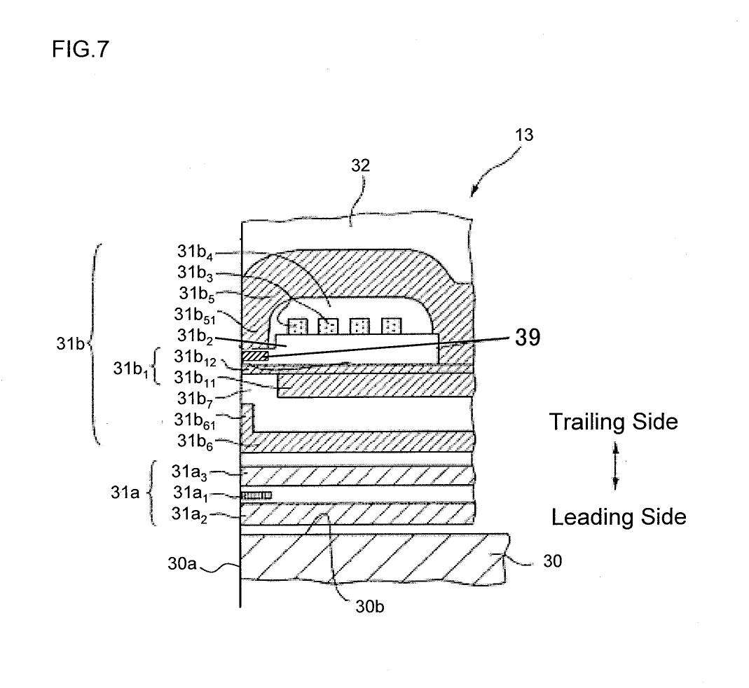

FIG. 7 is a cross-sectional view along the line A-A of FIG. 6. The MR reproducing head element 31a, the recording head element 31b, the microwave generating element 39, and the protective part 32 that protects these elements, are mainly formed above the element formation surface 30b of the magnetic head slider substrate 30 made of ALTIC (Al₂O₃—TiC).

The MR reproducing head element 31a includes an MR stack 31a₁, and a lower shield layer 31a₂ and an upper shield layer 31a₃ that are arranged in a position to sandwich the stack. The MR stack 31a₁ is composed of a current-in-plane (CIP) GMR multilayer film, a current-perpendicular-to-plane (CPP) GMR multilayer film, or a TMR multilayer film, and senses a signal magnetic field from the magnetic recording medium. The lower shield layer 31a₂ and the upper shield layer 31a₃ prevent effects from external magnetic fields, which would be noise for the MR stack 31a₁.

The recording head element 31b has a configuration for perpendicular magnetic recording. More specifically, the recording head element 31b is provided with a main pole layer 31b₁, a trailing gap layer 31b₂, a writing coil 31b₃ formed in a manner of passing between the main pole layer 31b₁ and an auxiliary pole layer 31b₅, a writing coil insulating layer 31b₄, the auxiliary pole layer 31b₅, an auxiliary shield layer 31b₆, and a leading gap layer 31b₇. The main pole layer 31b₁ is the main pole of the recording head element 31b, and generates a writing magnetic field from an end part of the ABS 30a side of the main pole layer 31b₁ at the time of writing data signals.

The main pole layer 31b₁ is a magnetic guide path. The magnetic guide path guides a magnetic flux to a magnetic recording layer of the magnetic recording medium while letting the magnetic flux focus. Herein, the magnetic flux is generated by applying a write current to the writing coil 31b₃, and the magnetic recording layer is a layer to which writing is conducted. The main pole layer 31b₁ is configured with a main pole yoke layer 31b₁₁ and a main pole major layer 311)₁₂.

The auxiliary pole layer 31b₅ and the auxiliary shield layer 31b₆ are arranged respectively in the trailing side and the leading side of the main pole layer 31b₁.

The end parts of the ABS 30a sides of the auxiliary pole layer 31b₅ and the auxiliary shield layer 31b₆ are respectively a trailing shield part 31b₅₁ and a leading shield part 31b₆₁ that each has a wider layer cross section than the other portions. The trailing shield part 31b₅₁ opposes the end part of the ABS 30a side of the main pole layer 31b₁ through the trailing gap layer 31b₂ therebetween. Further, the leading shield part 31b₆₁ opposes an end part of a magnetic head slider end surface 30d side of the main pole layer 31b₁ through the leading gap layer 31b₂ therebetween. By providing the trailing shield part 31b₅₁ and the leading shield part 31b₆₁ that are described above, a magnetic field gradient of a recording magnetic field between the end part of the trailing shield part 31b₅₁ and the end part of the main pole layer 31b₁ and between the end part of the leading shield part 31b₆₁ and the end part of the main pole layer 31b₁ becomes even steeper due to a magnetic flux shunt effect. As a result, signal output jitter is diminished, and thereby an error rate at the time of reading can be diminished.

It is also possible to provide a so-called side surface shield by suitably processing the auxiliary main pole layer 31b₅ or the auxiliary shield layer 31b₆ and arranging a portion of the auxiliary main pole layer 31b₅ or the auxiliary shield layer 31b₆ near both sides of the main pole layer 31b₁ in the track width direction. In this case, the magnetic flux shunt effect is enhanced.

The microwave generating element 39 is formed between the main pole major layer 311)₁₂ of the main pole layer 31b₁ and the trailing shield part 31b₅₁ of the auxiliary pole layer 31b₅.

FIG. 8 is a drawing of a configuration of the microwave generating element viewed from the element formation surface 30b of the magnetic head slider 13. The microwave generating element 39 exposed to the ABS surface of the magnetic head slider 13 and the terminal electrodes 36 and 37 are electrically connected by wiring members 40 and 41, and the microwave generating element 39 generates a microwave magnetic field by supplying a microwave excitation current from the terminal electrodes to apply the microwave magnetic field to the adjacent magnetic recording medium 10.

FIG. 9 is a cross-sectional view for explaining the principle of the microwave assisted magnetic recording method. The magnetic recording medium 10 is for perpendicular magnetic recording, and has a multilayered structure in which a magnetization orientation layer 10b, a soft magnetic under layer 10c that functions as a part of the magnetic flux loop circuit, an intermediate layer 10d, a magnetic recording layer 10e, and a protective layer 10f are sequentially laminated above a disk substrate 10a.

The magnetization orientation layer 10b stabilizes a magnetic domain structure of the soft magnetic under layer 10c to enhance suppression of spike noise in the reproducing output waveform by applying magnetic anisotropy in the track width direction to the soft magnetic under layer 10c. The intermediate layer 10d functions as a base layer that controls magnetization orientation and particle size of the magnetic recording layer 10e.

The ferromagnetic resonant frequency FR of the magnetic recording layer 10e is an inherent value determined by shape, size, configuration elements, and the like of magnetic particles that configure the magnetic recording layer 10e; however, generally it is approximately 1-50 GHz.

A microwave magnetic field is generated in the periphery of the microwave generating element 39 by applying a microwave excitation current to a conductor that configures the microwave generating element 39. A resonant magnetic field 80 is applied in a substantially in-plane direction of the magnetic recording medium within the magnetic recording medium because the microwave generating element 39 is adjacent to the magnetic recording medium. The resonant magnetic field 80 is a high-frequency magnetic field in the microwave frequency bands having the ferromagnetic resonant frequency FR of the magnetic recording layer 10e of the magnetic recording medium 10 or a frequency close to the ferromagnetic resonant frequency FR.

The coercive force of the magnetic recording layer 10e can be efficiently reduced by applying the resonant magnetic field 80 in a superimposition manner to a perpendicular recording magnetic field 81 that is applied to the magnetic recording layer from the main pole layer 31b₁ of the recording head element 31b. As a result, the intensity of the writing magnetic field in the perpendicular direction (perpendicular or substantially perpendicular direction to a top layer surface of the magnetic recording layer 10e), the writing magnetic field being necessary for writing, can significantly be reduced. When the coercive force is reduced, magnetization reversal is more likely to occur. Thereby recording can efficiently be conducted with a small recording magnetic field.

Next, transmission loss was calculated for various microwave transmission lines using thickness of a ground layer as a parameter. FIG. 4D illustrates a cross section of a transmission line as a comparative example. An insulating layer 50 (thickness of approximately 10 μm) made of polyimide and transmission lines 22a, 22b, and 22c (thicknesses of approximately 12 μm) made of Cu were formed on a flexure main plate 52 (thickness of approximately 18 μm) made of stainless. The flexure main plate 52 functioned as a ground for signal transmission in the microwave frequency bands. Each example had the configuration illustrated in FIG. 4B, and a ground layer 51 made of Cu with one of a variety of thicknesses was inserted between the flexure main plate 52 and the insulating layer 50. As another example, a configuration in which the flexure main plate itself was formed of Cu (thickness of approximately 18 μm) was also evaluated. It was assumed in the following analysis that only one micro transmission line was formed on the insulating layer. The length of the transmission line was 30 mm.

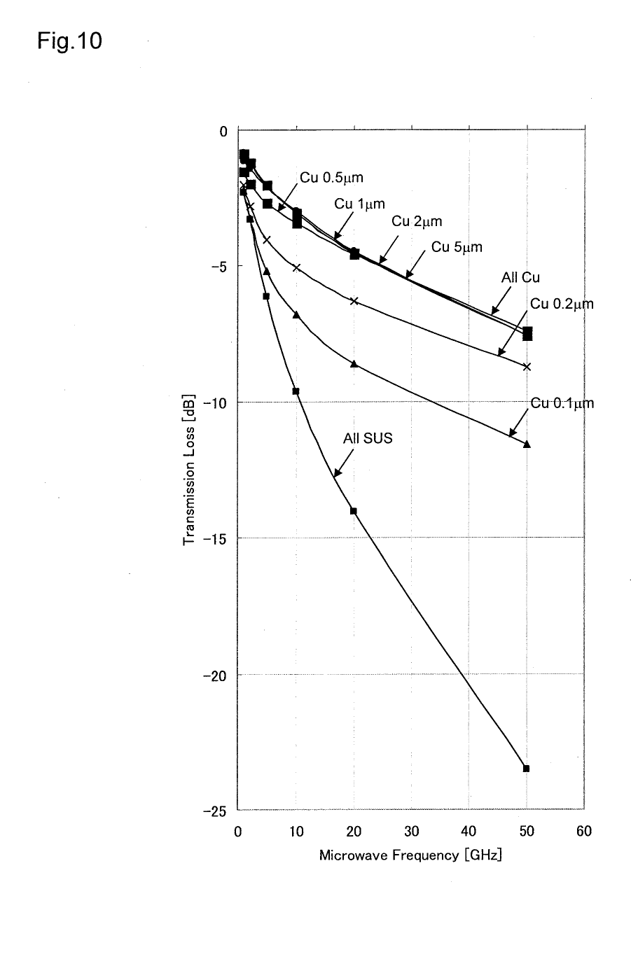

FIG. 10 illustrates the transmission loss of the microwave signals in the frequency region of 1-50 GHz. Illustrated are that the transmission losses of the case when the flexure main plate itself was made of Cu (All Cu), the case when the ground layer with various thicknesses of Cu (Cu 0.1 μm-Cu 5 μm) was provided on the flexure main plate made of stainless (conductivity 1.10×10⁶ [S/m]), and the case as the comparative example when the flexure main plate was formed of stainless and the ground layer was not provided (ALL SUS).

In the case when the flexure main plate itself was made of Cu (All Cu), significant improvement in the transmission loss was observed. At 30 GHz, for example, the loss was improved to about 6 dB as against the loss of 17 dB in the case of All SUS.

In the case of providing the ground layer 51, when the thickness of the ground layer was 0.1 μm or greater, a distinct loss improvement was observed. Accordingly, 0.1 μm can be considered as the lower limit of the thickness of the ground layer 51. When the thicknesses of the ground layer 51 were 2 μm and 5 μm, transmission loss characteristics thereof almost completely matched the case of All Cu (18 μm). In other words, when the film thickness was 2 μm or greater, the maximum improvement effects was obtained, and also the improvement effects were saturated. Meanwhile, in order to minimize the effect on the spring characteristics of the flexure from the viewpoint of the gimbal function, the thickness of the ground layer formed on the flexure main plate is preferably as thin as possible. Accordingly, the thickness of the ground layer is preferably less than 2 μm.

As described above, the thickness of the ground layer made of Cu formed on the flexure main plate made of stainless is preferably 0.1 μm or greater and less than 2 μm.

Loss improvement effects were also observed at 1 GHz that was the recording/reproducing signal band. Accordingly, the recording/reproducing signal loss can also be improved by providing the ground layer made of Cu under the transmission line for recording and the transmission line for reproducing.

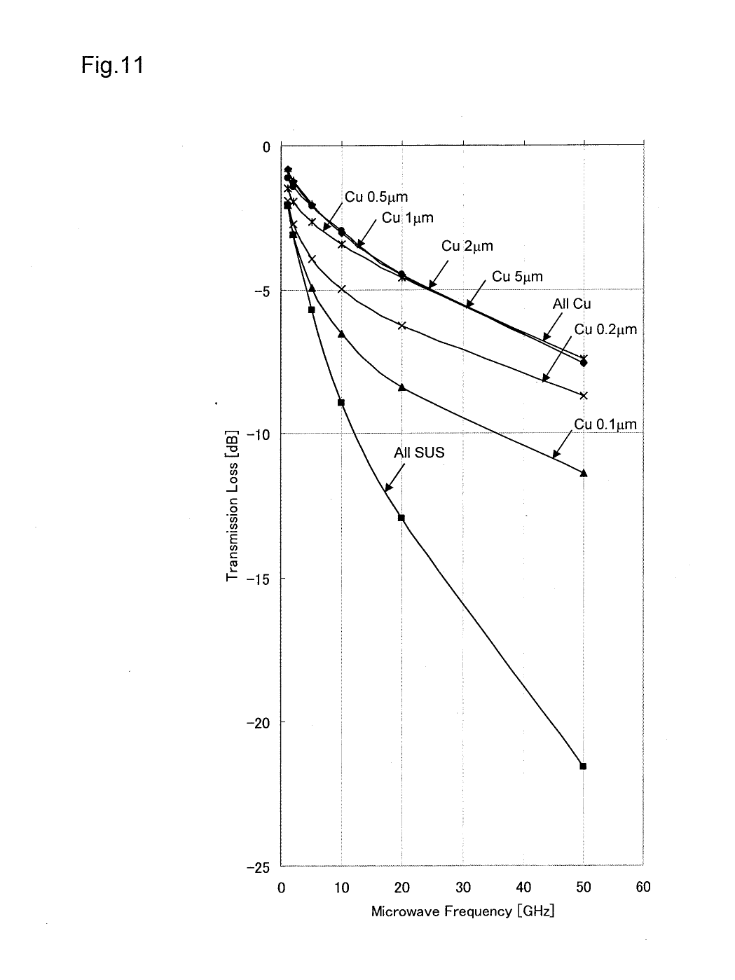

FIG. 11 illustrates the microwave signal transmission loss when stainless (1.39×10⁶ [S/m]) with different conductivity from that of the example described above was used as the flexure main plate. A distinct loss improvement was also observed in this case when the thickness of the ground layer was 0.1 μm or greater. Further, when the thicknesses of the ground layer were 2 μm and 5 μm, transmission loss characteristics thereof almost completely matched the case of All Cu (18 μm). Accordingly, the thickness of the ground layer made of Cu formed on the flexure main plate made of stainless is preferably 0.1 μm or greater and less than 2 μm. Beneficial effects of the ground layer were also observed at 1 GHz that is the recording/reproducing signal band.

From the results described above, it is evident that the transmission characteristics can be improved by providing a ground layer with high-conductivity of a thickness 0.1-2 μm regardless of the conductivity of flexure main plate. The material of the flexure main plate in which the spring characteristics are important can be selected from the viewpoint of preferable spring characteristics regardless of the electrical characteristics. For example, a resin material having a preferable elasticity such as engineering plastic material, polycarbonate, or the like can also be used as a material for the flexure main plate.

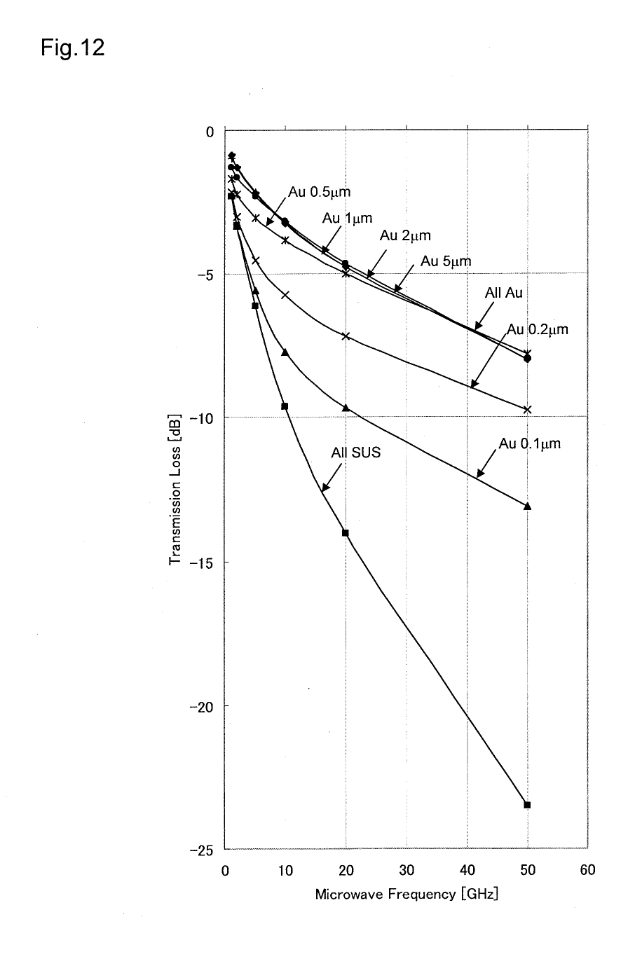

FIG. 12 illustrates the microwave transmission loss when Au having different conductivity from Cu was used as the ground layer. A distinct loss improvement was also observed in this case when the thickness of the ground layer is 0.1 μm or greater. Further, when the thicknesses of the ground layer were 2 μm and 5 μm, transmission loss characteristics thereof almost completely matched the case of All Au (18 μm). Accordingly, the thickness of the ground layer made of Au formed on the flexure main plate made of stainless is preferably 0.1 μm or greater and less than 2 μm. Beneficial effects of the ground layer were also observed at 1 GHz that is the recording/reproducing signal band.

According to the present results, it is evident that transmission characteristics are improved by providing a ground layer with higher conductivity than that of the flexure main plate regardless of material type of the ground layer. The material of the ground layer can be suitably selected from the viewpoint of processing, cost, and the like.

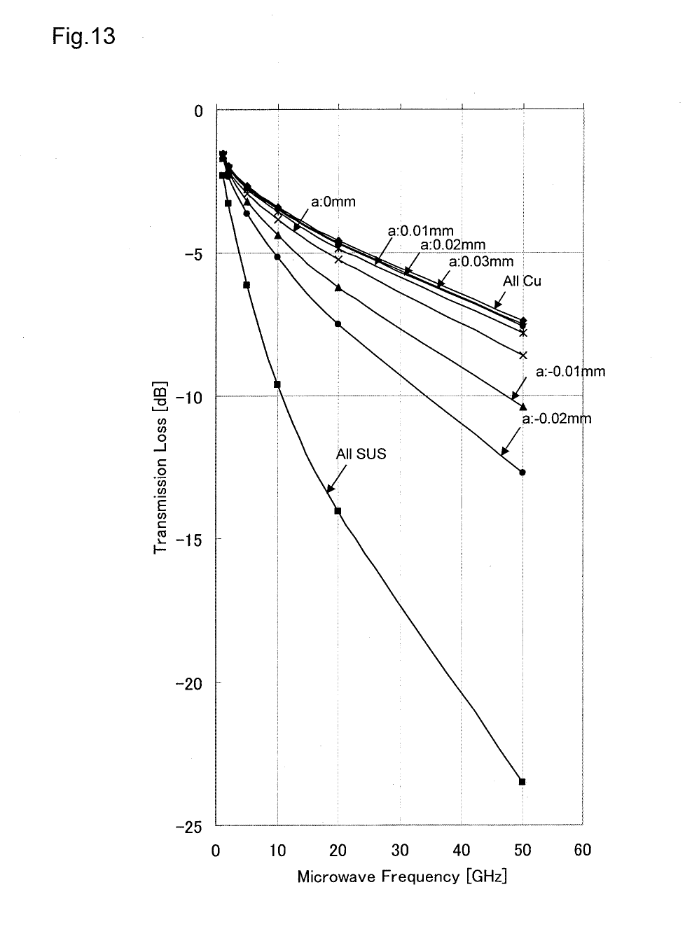

FIG. 13 illustrates a dependency on the width W1 (refer to FIG. 4C) of the ground layer in microwave transmission loss. The letter “a” in the drawing is defined as “the width (W1) of the ground layer—the width (W2) of the microwave transmission line.” There was a sufficient loss improvement effect when the width (W1) of the ground layer was equal to or greater than (a≧0) the width (W2) of the transmission line, and even when the width was further increased, the effect was almost saturated. However, it may be an advantage to provide the ground layer on the entire surface of the flexure main plate from a manufacturing viewpoint. Accordingly, it is preferable to set at the width (W1) of the ground layer≧the width (W2) of the microwave transmission line.

Next, the microwave signal transmission loss in the case of the suspension structure having a separate support part is illustrated. This case had a configuration in which no ground layer was provided in the separate support part (FIG. 5B), and a ground layer 51 made of a conductive material (copper, gold) was provided in the flexure main body part (FIG. 5C). The ground layer 51 functioned as a ground in the flexure main body part. A comparative example had a structure in which the ground layer 51 is removed from FIG. 5C.

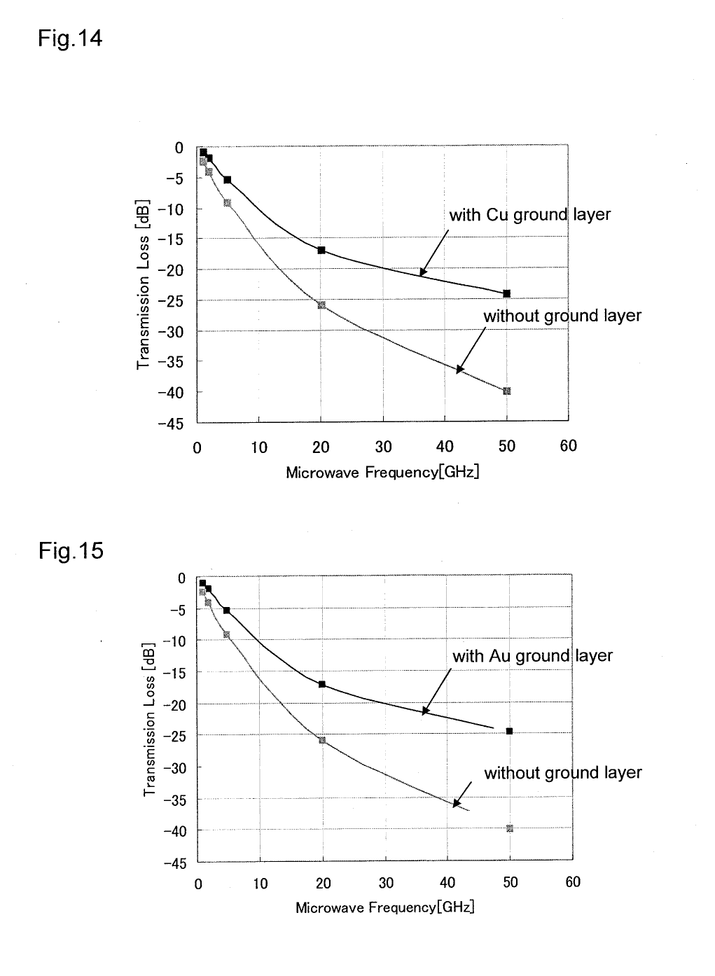

FIG. 14 illustrates the transmission loss of the microwave signals in a configuration where a copper (Cu) layer was provided as the ground layer in the flexure main body part. Likewise, FIG. 15 illustrates the transmission loss of the microwave signals in a configuration where a gold (Au) layer was provided as the ground layer.

In either configuration, the transmission loss was significantly improved in the example compared to the comparative example. This is because the ground layer with higher conductivity than that of the stainless layer provided in the flexure main body part functioned as the ground at the time of microwave signal transmission and therefore the transmission loss was reduced.

Since the transmission loss improvement effects shown in FIG. 14 and FIG. 15 were almost the same, the effect of the material type of the ground layer provided in the flexure main body part were small. Accordingly, the material type of the ground layer can be selected suitably from processing requirements and cost.

According to the embodiment described above, the suspension is configured from the flexure and the load beam, and the load beam functions to press the magnetic head slider against the surface of the magnetic recording medium with a prescribed pressure. On the other hand, the flexure may also functions as described above by adjusting the thickness, the material type, and the shape of the flexure. For example, it is possible to have the shape in which the width of the flexure becomes gradually wider toward the mounting direction of a drive arm 18. It is evident that similar effects can be obtained from a suspension configured only with such a flexure.

Several preferable embodiments of the present invention have been illustrated and described in detail; however, it is understood that various changes and modifications can be made without departing from the essence and scope of the attached claims.

What is claimed is:

1. A suspension that is configured to support a magnetic head slider having a recording head element for recording data signals to a magnetic recording medium and a microwave generating element that applies a high-frequency magnetic field to the magnetic recording medium when recording to the magnetic recording medium is conducted by the recording head element, comprising:
a flexure that supports the magnetic head slider and a microwave signal transmission line supported by the flexure, the microwave signal transmission line being connected to the microwave generating element and configured to transmit microwave signals for generating the high-frequency magnetic field, wherein
a portion that supports the microwave signal transmission line of the flexure includes a lamination structure in which a flexure main plate, a ground layer with the thickness of 0.1 μm or greater and less than 2 μm and having higher conductivity than that of the flexure main plate, and an insulating layer that supports the microwave signal transmission line are laminated in this order.

2. The suspension according to claim 1, wherein
the microwave signal transmission line is configured to transmit microwave signals of 1-50 GHz.

3. The suspension according to claim 1, wherein
a width of the ground layer is equal to or greater than a width of the microwave transmission line.

4. The suspension according to claim 1, wherein
the flexure main plate is made of a metal.

5. The suspension according to claim 4, wherein
the flexure main plate is formed of stainless steel, and the ground layer is formed of copper, gold, or silver, or an alloy of these.

6. The suspension according to claim 4, wherein
the flexure main plate is made of a material having higher conductivity than the stainless steel.

7. The suspension according to claim 1, wherein
the flexure has a main body part, a support part for the magnetic head slider, and a linkage part that links the main body part to the support part,
the microwave signal transmission line is supported between the main body part and the support part by a separate support part, which has an insulating property and which is provided separately from the flexure.

8. The suspension according to claim 1, wherein
the suspension is connected to the recording head element, has a recording signal transmission line to transmit recording signals, and a portion that supports the recording signal transmission line of the flexure has the lamination structure.

9. The suspension according to claim 1, wherein
the magnetic head slider has a reproducing head element for reproducing data signals from the magnetic recording medium, the suspension has a reproducing signal transmission line that is connected to the reproducing head element to transmit reproducing signals, and a portion that supports the reproducing signal transmission line of the flexure has the lamination structure.

10. The suspension according to claim 1, further comprising:
a load beam connected to an arm that conducts positioning of the magnetic head slider above the magnetic recording medium, wherein
the flexure is linked to the load beam.

11. The suspension according to claim 1, wherein
the flexure is connected to an arm that conducts positioning of the magnetic head slider above the magnetic recording medium.

12. A head gimbal assembly, comprising:
the suspension according to claim 1 and the magnetic head slider.

13. A magnetic recording device, comprising:
a head gimbal assembly according to claim 12;
a microwave signal generation circuit connected to the microwave signal transmission line, and a control unit of the microwave signal generation circuit.
